(19) United States
(12) Patent Application Publication
(10) Pub. No.: US 2014/0229205 A1
(43) Pub. Date: Aug. 14, 2014

(54) GLOBAL INSURANCE COMPLIANCE MANAGEMENT SYSTEM

(71) Applicant: G WIZICON TECHNOLOGIES, INC., Southfield, MI (US)

(72) Inventor: Herbert E. Gibson, Detroit, MI (US)

(73) Assignee: G WIZICON TECHNOLOGIES, INC., Southfield, MI (US)

(21) Appl. No.: 14/178,138

(22) Filed: Feb. 11, 2014

Related U.S. Application Data
(60) Provisional application No. 61/763,418, filed on Feb. 11, 2013.

(51) Int. Cl. G06Q 40/08

(52) U.S. Cl. CPC G06Q 40/08
USPC 705/4

(57) ABSTRACT

A computer based system for managing insurance compliance may comprise a computer, software, data storage, secured web services platform connecting the software to the data storage, and user interface for a user stakeholder to access insurance data of other stakeholders including insurance agencies, insurance carriers, policy holders, and verifier entities. A method for managing insurance compliance may comprise providing a dashboard interface to a user stakeholder, receiving login information to access an insurance status, and indicating the insurance status to the user stakeholder. A further method may comprise comparing the insurance contract terms to the insurance status to determine contract compliance and indicating contract compliance.

### CROSS-REFERENCE TO RELATED APPLICATIONS

This application claims priority to U.S. Provisional Patent Application No. 61/763,418, filed Feb. 11, 2013, the contents of which are hereby incorporated in their entirety.

### TECHNICAL FIELD

A computer based management system (CMS) for increasing insurance compliance, and more particularly, an interactive networked computer system for use with the property and casualty insurance industry that is dynamic, and provides a common global insurance servicing platform with interactive stakeholder applications that manage compliance, for example, through at least compliance standardization, cost minimization, consumer protection, lower claims activity, and improved outcomes.

### BACKGROUND

The insurance industry is a significant part of the U.S. economy and impacts nearly every citizen whether he or she is part of the private sector or the business sector. In the property and casualty insurance industry there is a lack of standardization in managing insurance compliance between and among the numerous stakeholders. A stakeholder may include an insurance agency, insurance carrier, policyholder, verifiers (i.e. third parties), or others that may seek insurance data.

There is currently a lack of risk transfer controls that may lead to fraud, abuse, and misrepresentation by agents and insureds. There also exists extension of insurance certificates beyond their intended use to meet contractual obligations. Another problem is the rising costs of agency-produced certificates that are issued to verifier entities where there is no business relationship. In addition, there is a rise in errors and omissions (E&O) claims from mismanagement of insurance certificates in particular additional insured status.

It is a goal of many stakeholders in the insurance industry to manage the insurance compliance process for the benefit of all stakeholders and all industries globally. By doing so, cost savings may be realized by the insurance agencies, insurance carriers, policyholders, and verifier entities. However, one of the problems with the compliance aspect of the insurance industry is that it relies on a distribution network of agencies and brokers to effectuate insurance transactions on behalf of carriers. However, agency contract compliance is often difficult and tedious operation of an agency's compliance department considering the associated regulations to be managed. The cost to agencies of verifier certificate compliance is substantial.

Some insurance carriers have a large task force of insurance agencies with each of them being monitored or tracked for compliance. For example, insurance carriers have to track the errors and omissions coverage compliance. This becomes burdensome to the insurance carrier in both man power and monetary considerations. If this task is not monitored carefully, the insurance carrier may be subjected to unnecessary claims and liability in the event an insurance agency was not following protocol.

For example, an insurance agency may be selling insurance on behalf of a carrier. It may be that the agency met the compliance requirements at the beginning of the contract. However, several years later into the contract the agency may let the errors and omissions coverage of the policy lapse while continuing to conduct insurance transactions on the carrier's behalf. This sort of out-of-compliance event is costly to the carriers. And unfortunately, traditional insurance compliance systems are unable to detect or resolve this issue thereby increasing overall insurance costs.

The cost to monitor compliance is typically borne by the insurance carriers and it often is through the deployment of substantial human capital. For example, if an agency buys an errors and omissions policy from a carrier whose A&M Best Rating is A-, but the rating then drops to B- or worse, then this contract is non-compliant. If the agency does not bring this to the attention of the insured, then the insured may have issues with the non-conforming contract. To monitor these types of out-of-compliant events requires substantial human capital. The insurance industry is cutting back on man power, which further cuts back the level of compliance monitoring. It would be helpful to provide an automatic and real-time active/inactive agency errors and omissions compliance status feature. Such would not depend on the large human capital infrastructure we have become accustomed to needing in traditional compliance departments.

It has also become burdensome in the insurance industry for verifiers to request and then to acquire from their vendors copies of their insurance certificates for compliance purposes. To do so would require several people to become involved and it would often take too long of a period to complete the delivery of the confirmation insurance certificate copies to the verifier. And in some instances, the policy may have lapsed and the verifier may not even be informed of this important event due to the lack of accountability and communication within the insurance ecosystem.

It would be desirable to provide an improved insurance compliance system. For example, a system that may inform an insurance carrier that an agency was out of compliance would be helpful and would add credibility and reliability to the system. Such a system may also reduce claims exposure for non-compliant or rogue agencies.

It would also be helpful to provide an improved insurance system that regularly updates a database of active/inactive insurance policies and automatically notifies the interested shareholders with contract interest. It would also be helpful to provide a notification feature to insurance agencies that informs interested shareholders when a client allows its insurance to cancel after the policy is in force. If an agency sees a pattern of this conduct, it can choose to no longer write policies for such clients. Such an improved system may provide an increase in consistent premiums being paid and thus policies in force due to enhanced system accountability.

A Global Active Policy Repository Optimization (GAPRO) System for use in the insurance industry is contemplated. Such a system may include a computer, a software program operating on the computer, a data verification warehouse, a real-time information reporting module, a user interface including a dashboard, and continuous access for any stakeholder in any location. It would be helpful to provide such a system that may help insurance carriers track agency compliance at all times, as well as provide information to other stakeholders in the insurance ecosystem.

### BRIEF DESCRIPTION OF THE DRAWINGS

While the claims are not limited to a specific illustration, an appreciation of the various aspects is best gained through a discussion of various examples thereof. Referring now to the drawings, exemplary illustrations are shown in detail. Although the drawings represent the illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows:

FIG. 1 illustrates an exemplary embodiment of the present disclosure including a multi-sided platform for shareholders to access insurance information;

FIG. 2 illustrates an exemplary embodiment of the present disclosure, for example, including shareholders, network architecture, and modules;

FIG. 3 illustrates an exemplary compliance manager module of the present disclosure;

FIG. 4 illustrates an exemplary graphical representation of a user interface of the present disclosure;

FIG. 5 illustrates another exemplary graphical representation of a user interface, for example, including modules for insurance agencies, insurance carriers, policy holders, and verifier entities;

FIG. 6 illustrates an exemplary graphical representation of a policy holder interface;

FIG. 7 illustrates an exemplary graphical representation of an insurance carrier interface;

FIG. 8 illustrates an exemplary graphical representation of an insurance agency interface;

FIG. 9 illustrates an exemplary graphical representation of a verifier interface;

FIG. 10 illustrates an exemplary graphical representation of a compliance management page of the present disclosure;

FIG. 11 illustrates another exemplary graphical representation of a compliance management page, for example, including a spreadsheet listing with data sorting;

FIG. 12 illustrates another exemplary graphical representation of a compliance management page, for example, including searchable views, E&O policy information, and license status by state;

FIG. 13 illustrates another exemplary graphical representation of a compliance management page, for example, including an agency compliance manager and avatar contact manger;

FIG. 14 illustrates another exemplary graphical representation of a compliance management page, for example, including sorting by user type and a pie chart of active and inactive status;

FIG. 15 illustrates another exemplary graphical representation of a compliance management page, for example, including an ability to upload information by contract type, upload information by agency E&O policy information, and view and manage by contract type; and

FIG. 16 illustrates another exemplary graphical representation of a compliance management page, for example, including a sortable listing spreadsheet.

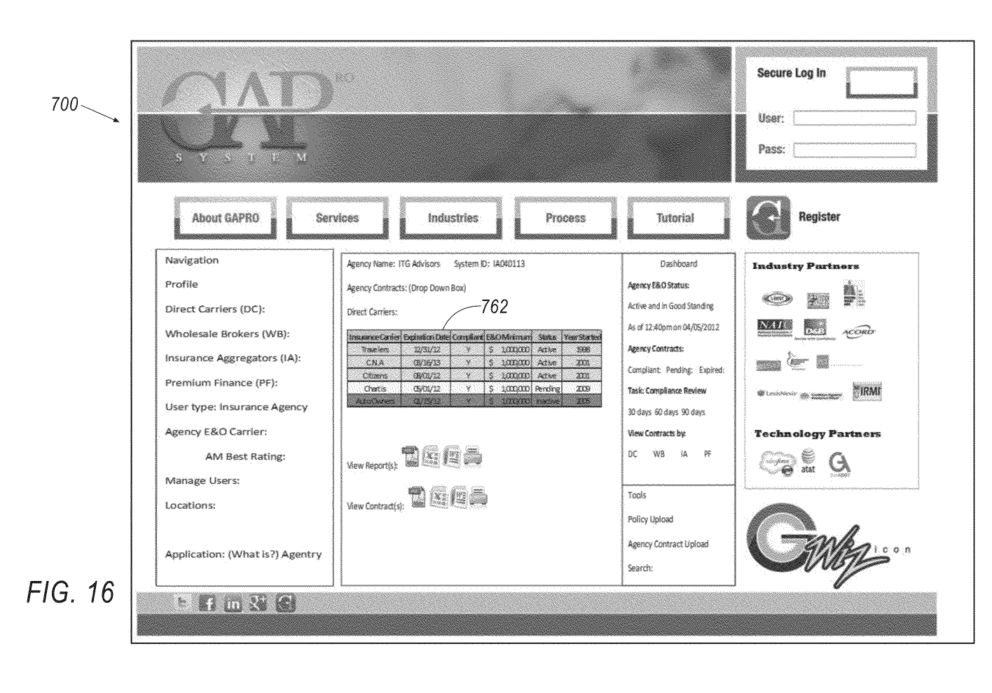

### DETAILED DESCRIPTION

A computer based system for managing insurance compliance may be provided. The system comprise computer, software that may be configured to receive login information of a stakeholder including at least one of an insurance agency, insurance carrier, policy holder, or verifier (i.e. third party) entity, data storage including insurance data of other stakeholders including insurance agencies, insurance carriers, policy holders, and verifier entities, a secured web services platform connecting the software to the data storage; and a user interface for the user stakeholder to access insurance data of the other stakeholders. The system may be a tool to manage insurance compliance.

Methods for managing insurance compliance are also contemplated. A method may comprise providing a user interface connecting a computer to a database, receiving login information to access an insurance status from the database, the insurance status information being of an insurance agency, insurance carrier, policy holder, or verifier entity, and indicating the insurance status to the user. A further method may comprise providing a user interface connecting a computer to a database, receiving login information to access insurance data from the database, the insurance data including insurance contract terms and insurance status, comparing the insurance contract terms to the insurance status to determine contract compliance, and indicating contract compliance to the user interface.

The system may track and manage an insurance agency's compliance with its insurance carrier's contract compliance requirements. The system may provide the following features: AM Best tracking of agency errors and omissions (E&O) carriers, real-time active/inactive agency E&O status updates, notification alerts of carrier contract renewal status, tracking of carrier and broker appointments by contract type, secure centralized agency E&O policy listing repository with retroactive date tracking, and dashboard access view of contracted carriers and brokers with sorting detail. The benefits of an improved insurance compliance system may include reduction of the time dedicated to contract renewal, redistribution of man hours as a result of the system productivity improvements, increased consistency of carrier compliance, easier access to compliance data at all times, reduction in insurance fraud, reduction in E&O claims, increase in policies in force, transparency of agency relationships, expedited contract award and contract disablement process, standardization of requirements, increase in premiums in force, and reduction in commission charge backs to agencies.

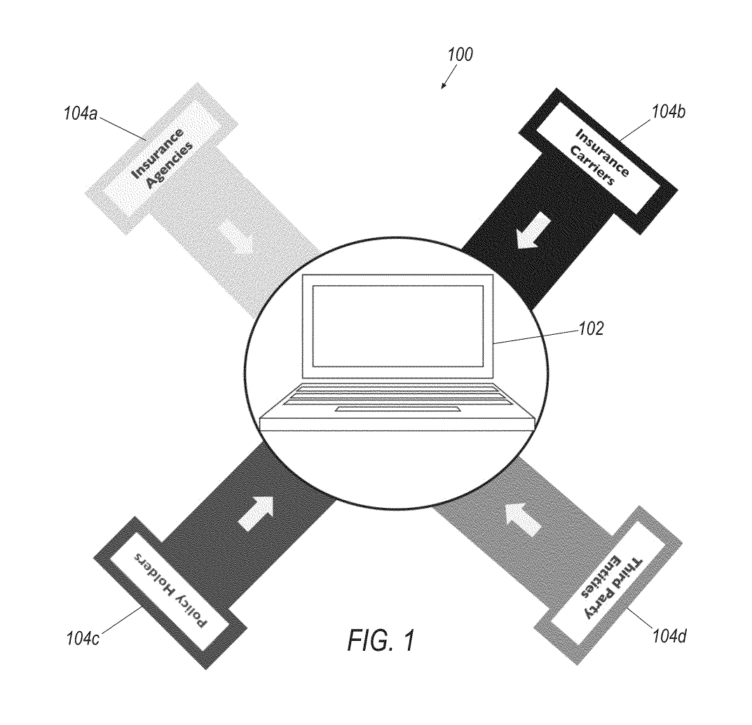

With reference to FIG. 1, the system 100 may include a multi-sided web service platform for the insurance industry, for example, to manage insurance compliance. The system may include central computer 102 with software and data storage that is accessible to the internet. A secured web services platform is offered that interfaces with the insurance industry and is operable to manage insurance compliance in real-time for stakeholders 104. For example, stakeholders 104 may include insurance agencies 104a, insurance carriers 104b, policy holders 104c, and verifier (i.e. third party) entities 104d. System 100 may provide shared efficiency and reduction in cost. System 100 may be scalable and provide a human interface for which stakeholders 104 communicate insurance compliance needs. System 100 may utilize a Platform as a Service (PaaS) model based on a monthly, quarterly, or annual subscription or month-to-month or as-needed transactional fees. Thus, a tool and method is provided for resolving the previous compliance concerns that remain in the industry.

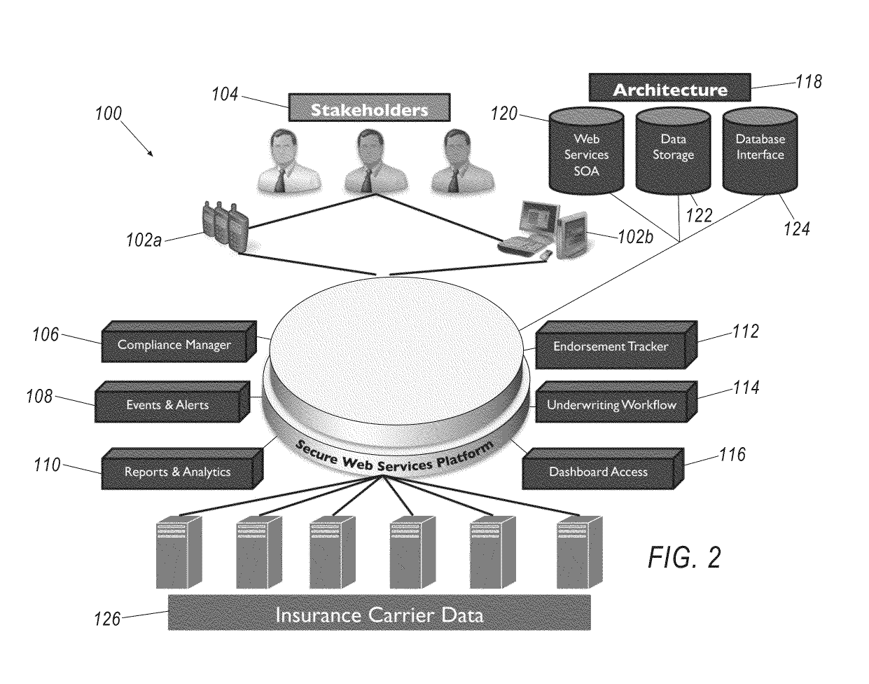

Each stakeholder 100 may be provided with a porthole to system 100 as shown in FIG. 2. System 100 may be accessed through computer 102, for example mobile phone 102a or a desktop, laptop, or tablet computer 102b. Modules may be individualized for each type of stakeholder 104. Exemplary modules may include Compliance Manager 106, Events and Alerts 108, Reports and Analytics 110, Endorsement Tracker 112, Underwriting Workflow 114, and Dashboard Access 116. Also, system 100 may utilize security features such as password protection, intrusion detection, intrusion prevention, cyber risk liability, web application firewall, and penetration testing. The network architecture 118 of system 100 may include web services oriented architecture (SOA) 120, data storage 122, and database interface 124. System 100 provides secure, efficient, and real-time access to insurance data 126 for various types of stakeholders 100. Insurance data 126 may include or relate to, for example, verification or proof of insurance, endorsement of additional insured status, notice of cancellation, waiver of subrogation endorsement, primary and non-contributory endorsement, coverage and limit matching information, or any other relevant information.

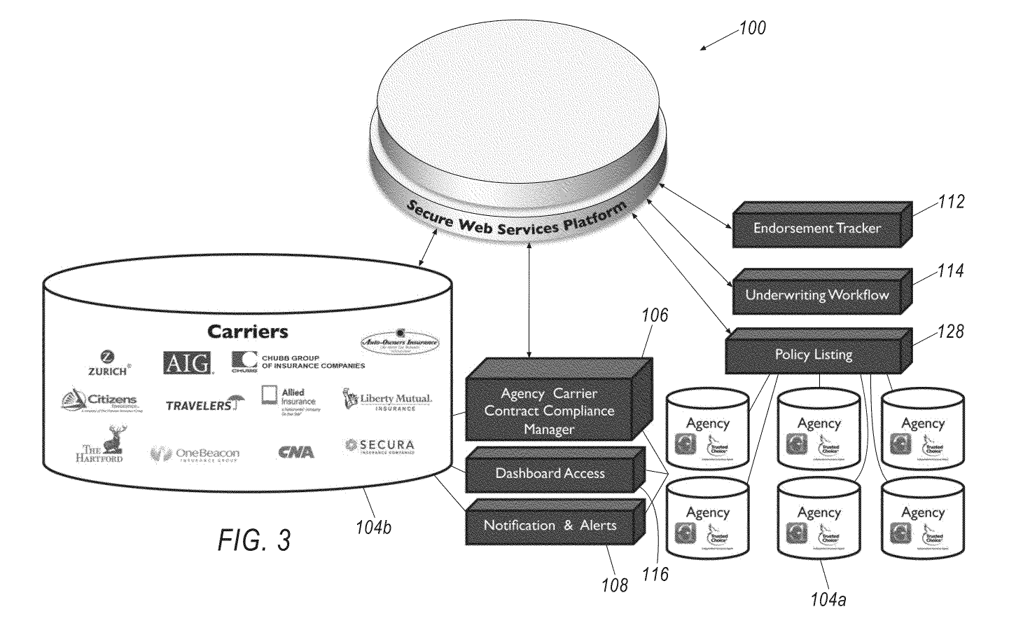

Referring to FIG. 3, compliance manager 106 may coordinate relevant information between stakeholders 104 (i.e. agencies 104a and carriers 104b) to promote contract compliance. For example, compliance manger 106 may manage errors and omissions compliance with contracted agencies 104a. Operational transparency may be provided between types of stakeholders 104 with dashboard access 116 and automatic notifications and alerts 108. Dashboard access 116 may allow stakeholders 104 (i.e. insurance carriers 104b) to access the insurance data 126 of other stakeholders 104 (i.e. insurance agencies 104a) to track policy listings 128, underwriting workflow 114, and endorsements 112. Policy listing 128 may include real-time agency E&O policy listings for access verification. Also, notifications/events and alerts 108 may provide real-time updates to the activities of other stakeholders in the insurance process, for example, by providing notification of non-compliant agencies. In addition, dashboard access 116 my include analytics that may provide a view of an agency tree and other analytics relevant to each type of stakeholder 104. Insurance data 126 may be built in real-time or on a daily basis, which may be communicated with system 100 and accessed by computer 100.

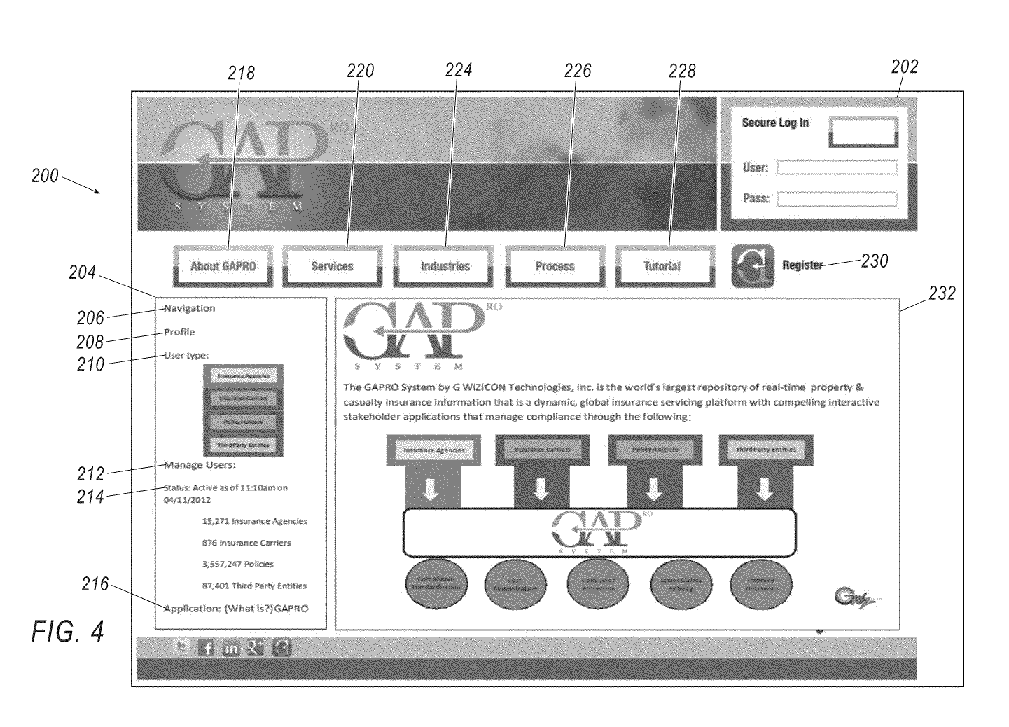

FIG. 4 illustrates an exemplary graphical representation of a user interface 200 for system 100. User interface 200 may be accessible by stakeholders 104 and configurable by a central host for operation and control of system 100. User interface 200 may be generated by computer 102 and accessed via the internet. User interface 200 may include a secure login 202 configured to receive a user name and password. User interface 200 may include a dynamic platform with dashboard 202 providing a repository of real-time insurance data 126 (i.e. property and casualty insurance data) with interactive stakeholder applications to manage insurance compliance. Dashboard 204 may include navigation 206, profile 208, user type 210, manage users 212, status 214, and application 216. Status 214 may include active and inactive policy status real-time. User interface 200 may also include links such as about 218 (i.e. information about the company), services 220, industries 224, process 226, tutorial 228, and register 230 (i.e. to register as a new user). Intro 232 may include an overview of system 100.

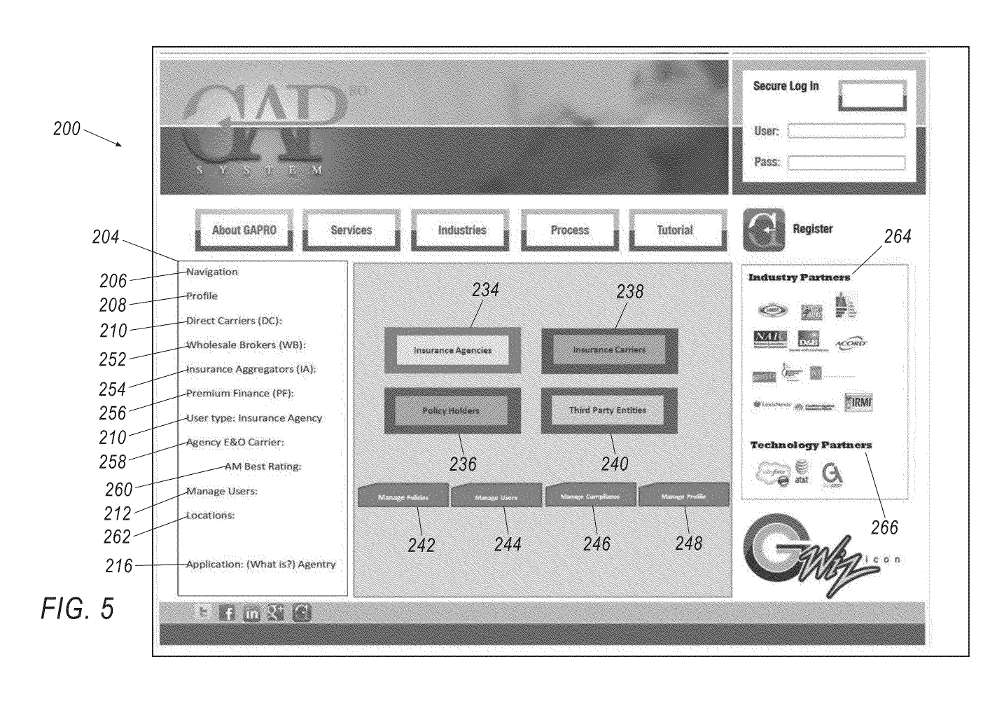

Further, FIG. 5 illustrates another exemplary graphical representation of a user interface 200. User interface 200 may include a tab for each stakeholder, for example tabs including insurance agency 234, policy holder 236, insurance carrier 238, and verifier entity 240. User interface 200 may further include tabs that manage policies 242, manage users 244, manage compliance 246, and manage profile 248 are provided. Dashboard 206 may link to information site navigation 206, user profile 208, direct carriers (DC) 250, wholesale brokers (WB) 252, insurance aggregators (IA) 254, premium finance (PF) 256, user type 210, agency E&O carrier 258, AM Best Rating 260, manage users 212, locations 262, and application 216. Links to industry partners 264 and technology partners 266 may also be provided. User interface 200 may also include additional insured/notice of cancellation endorsement tracking, standardized insurance compliance requirements, policy language reference guide, compliance notification services, and global mobile access to policy data anytime.

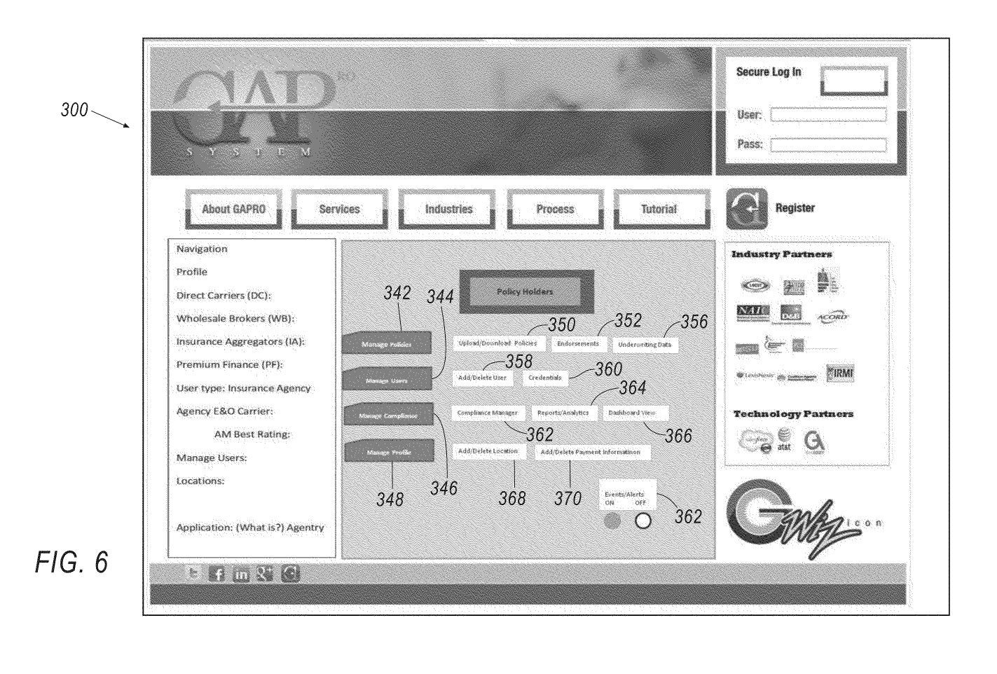

Upon clicking on the policy holder tab 236 of FIG. 5, a screen may propagate and provide policyholder interface 300 that may be configured for policy holder 104c. See FIG. 6. Policy holder interface 300 may provide policy holder 104c with access to information relating to its policy portfolio. Tabs may include manage policies 342, manage users 344, manage compliance 346, and manage profile 348. Manage policies 342 may include upload/download policies 350, endorsements 352, and underwriting data 356. Manage users may include add/delete user 358 and credentials 360. Manage compliance 346 may include compliance manager 362, reports/analytics 364, and dashboard view 366. Manage profile 348 may include add/delete location 368 and add/delete payment information 370. An events/alert tab 372 may be provided to signal predetermined or future events.

Policy holders 104c may receive a number of benefits from utilizing system 100. It may provide an easier process to request and receive endorsement status for additional insured. System 100 may improve accountability of the agent to client relationship. System 100 may increase transparency to ensure well-informed buying decisions and buyer protection, for example, with information from AM Best, ISO, ACORD, NIPR, and D&B. The added transparency of system 100 may reduce or eliminate fraudulent fiduciary activities by stakeholders 104. In addition, system 100 may provide easier access to insurance policy data 126 for facilitating contract compliance anytime and from anywhere in the world.

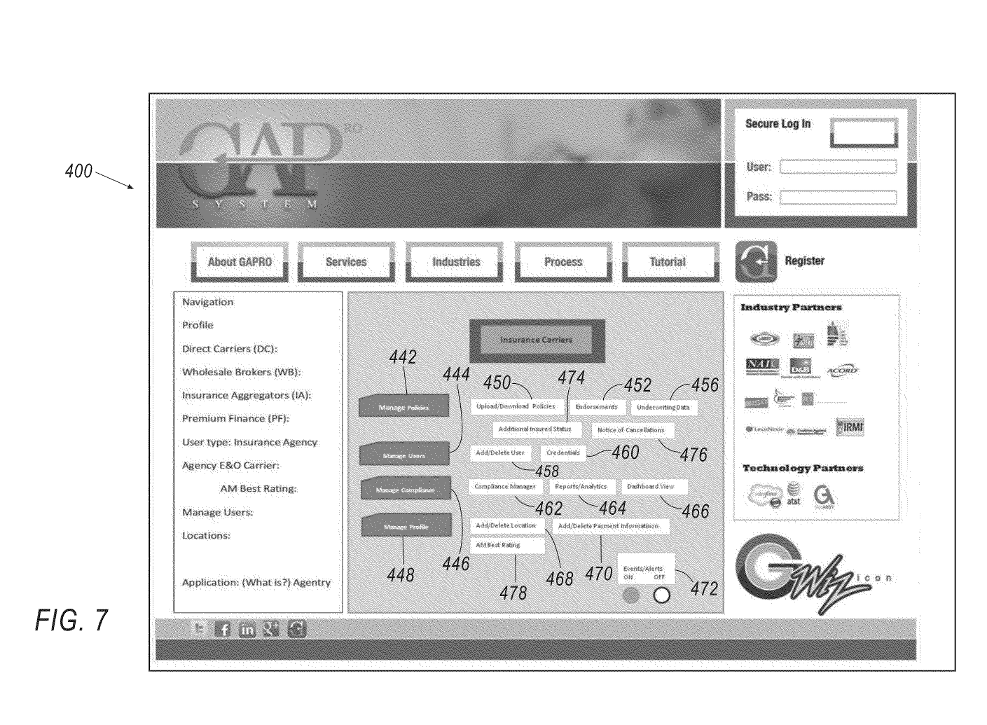

Upon clicking on the insurance carriers tab 238 as shown in FIG. 5, a screen may propagate and provide insurance carrier interface 400 that may be configured for insurance carrier 104b. See FIG. 7. Insurance carrier interface 400 may provide insurance carrier 104b with access to information relating to a policy portfolio for insurance carriers 104b. Tabs may include manage policies 442, manage users 444, manage compliance 446, and manage profile 448. Manage policies 442 may include upload/download policies 450, endorsements 452, underwriting data 456, additional insured status 474, and notice of cancellations 476. Manage users 444 may include add/delete user 458 and credentials 460. Manage compliance 446 may include compliance manager 462, reports/analytics 464, and dashboard view 466. Manage profile 448 may include add/delete location 468, add/delete payment information 470, and AM Best Rating 478. An events/alert tab 472 may be provided to signal predetermined or future events.

Insurance carrier users 104b may also receive a number of benefits from utilizing system 100. System 100 may provide an endorsement tracking tool for policy holder and verifier relationship statuses. System 100 may further provide an increase in consistency of premiums and policies in force. System 100 may also reduce claims exposure with compliance tools for representative agencies. Use of system 100 may result in a standardization of written contracts-to-policy forms. System 100 may also reduce or eliminate the burden of notifying verifiers of policy cancellations. In addition, system 100 may provide a reduction in insurance fraud, abuse, and misrepresentation.

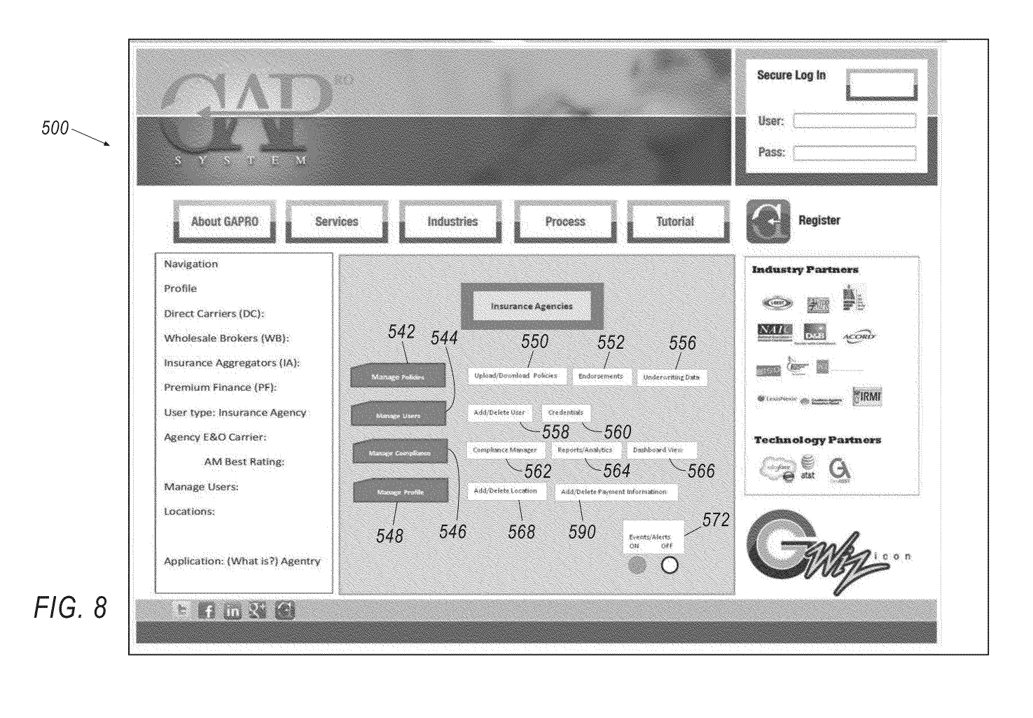

Upon clicking on the insurance agencies tab 234 that is shown in FIG. 5, a screen may propagate and provide insurance agency interface 500 configured for insurance agency 104a. See FIG. 8. Insurance agency interface 500 may provide an insurance agent with access to information relating to a policy portfolio for insurance agencies. Tabs may include manage policies 542, manage users 544, manage compliance 546, and manage profile 548. Manage policies 542 may include upload/download policies 550, endorsements 552, and underwriting data 556. Manage users 544 may include add/delete user 558 and credentials 560. Manage compliance 546 may include compliance manager 562, reports/analytics 564, and dashboard view 566. Manage profile 548 may include add/delete location 568 and add/delete payment information 570. Events/alert tab 572 may be provided to signal predetermined or future events.

Insurance agencies 104a may receive a number of benefits from system 100. System 100 may reduce commission charge back and dropping of insurance after contract approvals. E&O claims arising out of insurance certificate activity may be lowered. Policy endorsements and certificates cost may be lowered. Pressure may be reduced to produce misrepresented certificates of insurance. Insurance compliance requirements may be standardized in accordance with client insured contracts. System 100 may also increase compliance measures for an agency distribution system.

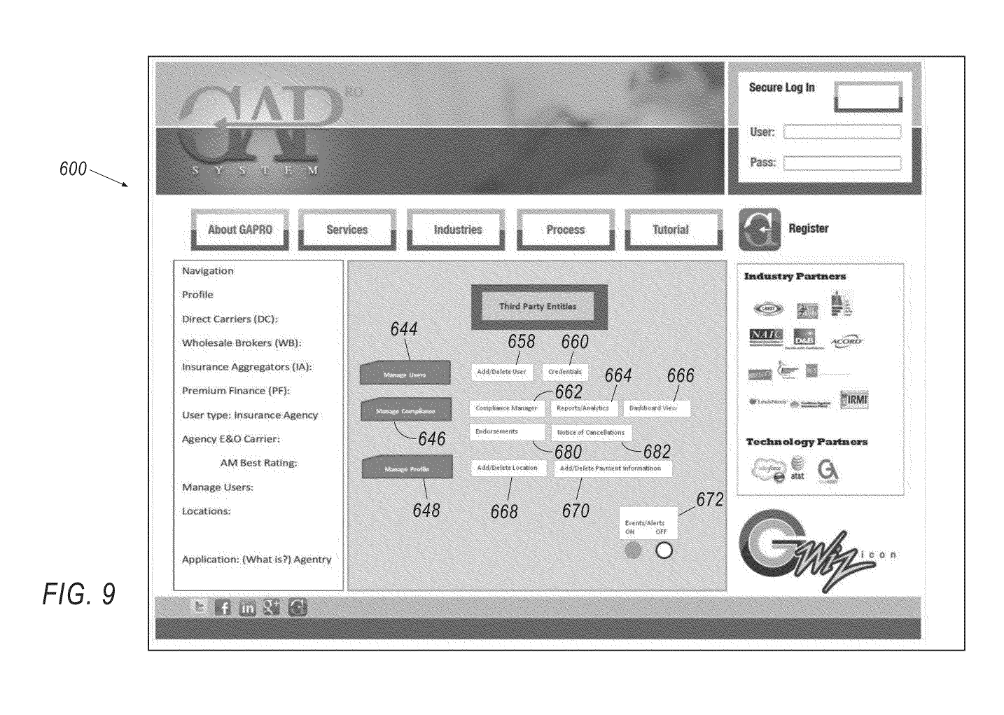

Upon clicking on the verifier entities tab 240 that is shown in FIG. 5, a screen may propagate and provide verifier interface 600 configured for verifier 104d. See FIG. 9. Verifier interface 600 may provide verifier 104d with access to information relating to a policy portfolio for verifier entities. Tabs may include manage users 644, manage compliance 646, and manage profile 648. Manage users 644 may include add/delete user 658 and credentials 660. Manage compliance 646 may include compliance manager 662, reports/analytics 664, dashboard view 666, endorsements 680, and notice of cancellations 682. Manage profile 648 may include add/delete location 668 and add/delete payment information 670. Events/alert tab 672 may be provided to signal predetermined or future events.

Verifier users 104d may also receive a number of benefits from utilizing system 100. System 100 may provide a reduction of expenses associated with insurance certificate management and vendor compliance. There may be a reduction of potential claims exposure for non-compliance or rogue vendors/subcontractors. System 100 may provide a more expedient contract award and contract disablement process to mitigate risk. There may be a standardization of insurance requirements to minimize risk exposures including real-time status updates. System 100 may provide for reduction or elimination of fraud and misrepresentation. In addition, there may be a redistribution of man hours from ease of use.

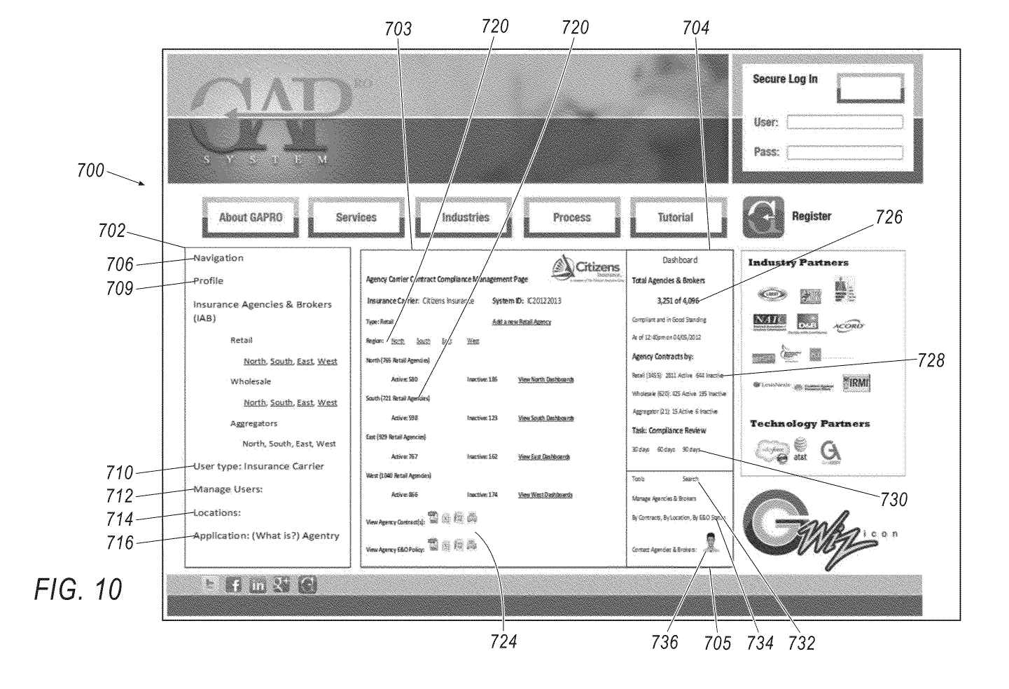

Referring to FIG. 10, user interface 700 may provide stakeholder 104 (i.e. insurance carrier 104b) with tools for managing compliance. User interface 700 may also provide real-time data in dashboards 702, 703, 704, and 705. Dashboard 702 may include tabs such as navigation 706, profile 708, insurance agencies and brokers 709, user type, 710, manage users 712, location 714, and application 716. Insurance agencies and brokers tab 709 of dashboard 702 may sort dashboard 704 by contract type (i.e. retail, wholesale, or aggregators) and by region (i.e. north, south, east, or west). Dashboard 703 may include area 718 with a name and system ID for the displayed insurance carrier, area 720 with an ability to view retail agencies by region, area 722 with a listing of the number of active and inactive agencies in each region and links to region specific dashboards, and area 724 with an ability to view repository of agency contracts and E&O policies. Dashboard 704 may include area 726 with real-time agency and broker information (i.e. indicating if compliant and in good standing), area 728 with an active and inactive indications with compliance by contract type modules, and area 730 with compliance review (i.e. determination of compliance and standing) over various time intervals, for example 30, 60, or 90 days. In addition, dashboard 705 may include area 732 with links to tools and searches, area 734 to manage agencies and brokers by contacts, location, or E&O status, and area 736 with an ability to contact agencies and brokers by clicking an avatar.

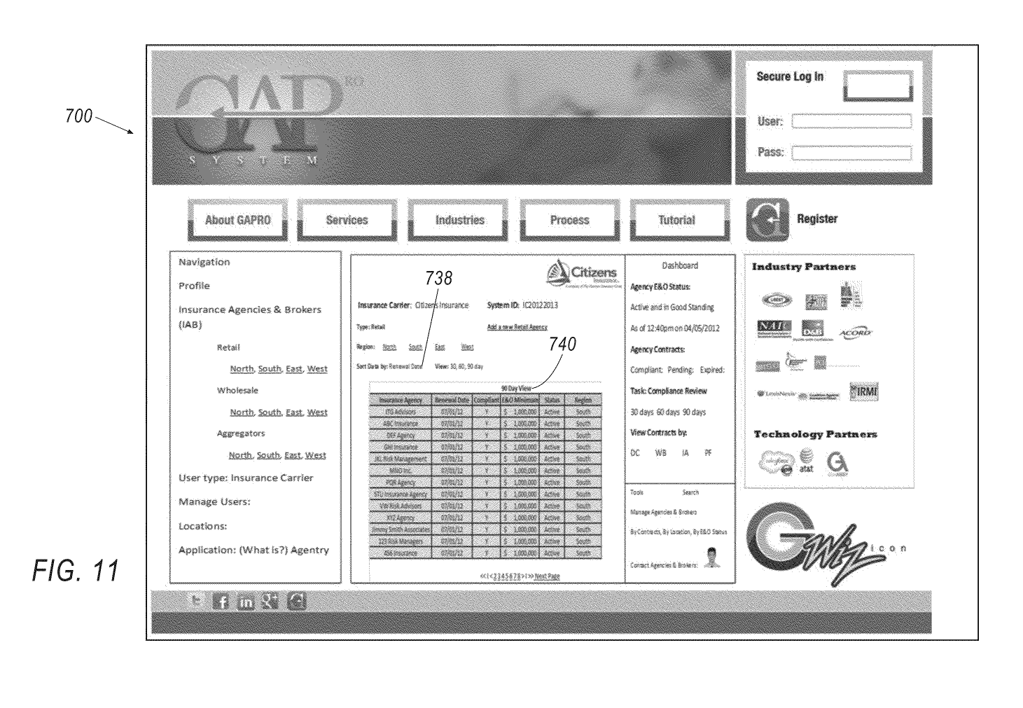

With reference to FIG. 11, user interface 700 may provide additional tools for stakeholders 104 (i.e. insurance agencies 104a) to utilize in order to manage compliance. For example, area 738 of user interface 700 may allow for data sorting by contract type, region, or renewal date and over various time intervals such as 30, 60, or 90 days. Also, area 740 may include a spreadsheet with rows that may be sorted by agency name, renewal date, compliance, E&O minimum, active or inactive status, and region. User interface 700 may also quantify the number of compliant, pending, and expired contracts.

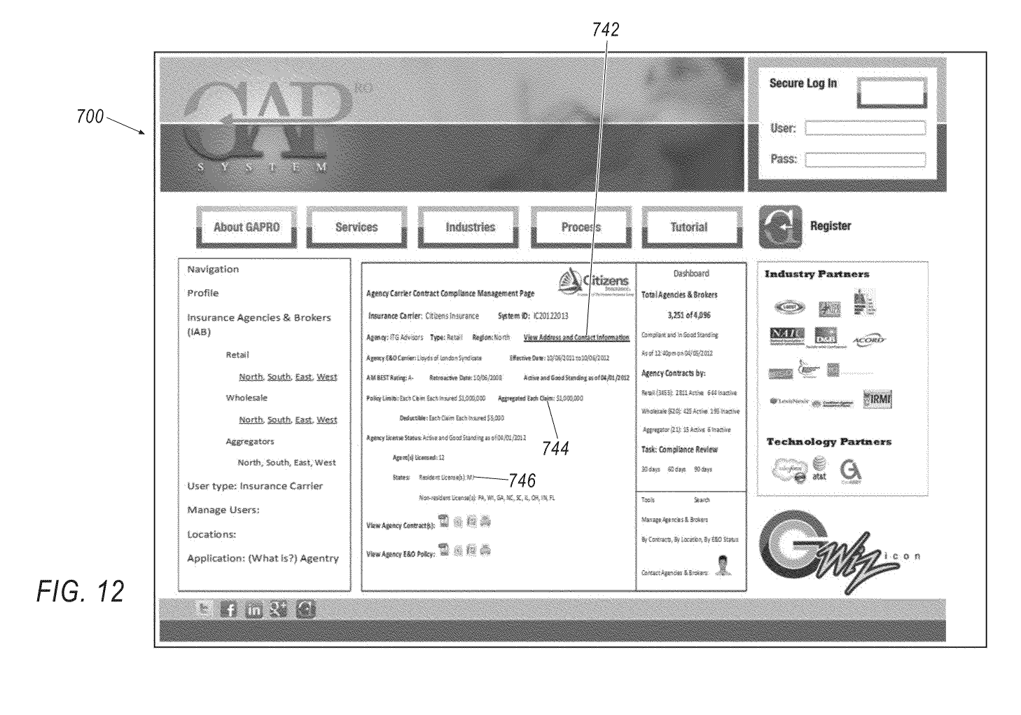

Referring to FIG. 12, user interface 700 may allow stakeholders 104 (i.e. insurance carriers 104b) to search 742 for individual agencies, review 744 agency E&O policy information, and review 746 agency/agent license status by state. User interface 700 may also provide agency details such as agency name, type, region, address and contact information, E&O carrier name, effective date, AM Best Rating, retroactive date, active and standing status, policy limits per claim per insured, aggregated limit per claim, deductible, agency license status, total number of licensed agents, license states, resident and non-resident licenses, and an ability to view agency contracts and the agency E&O policy.

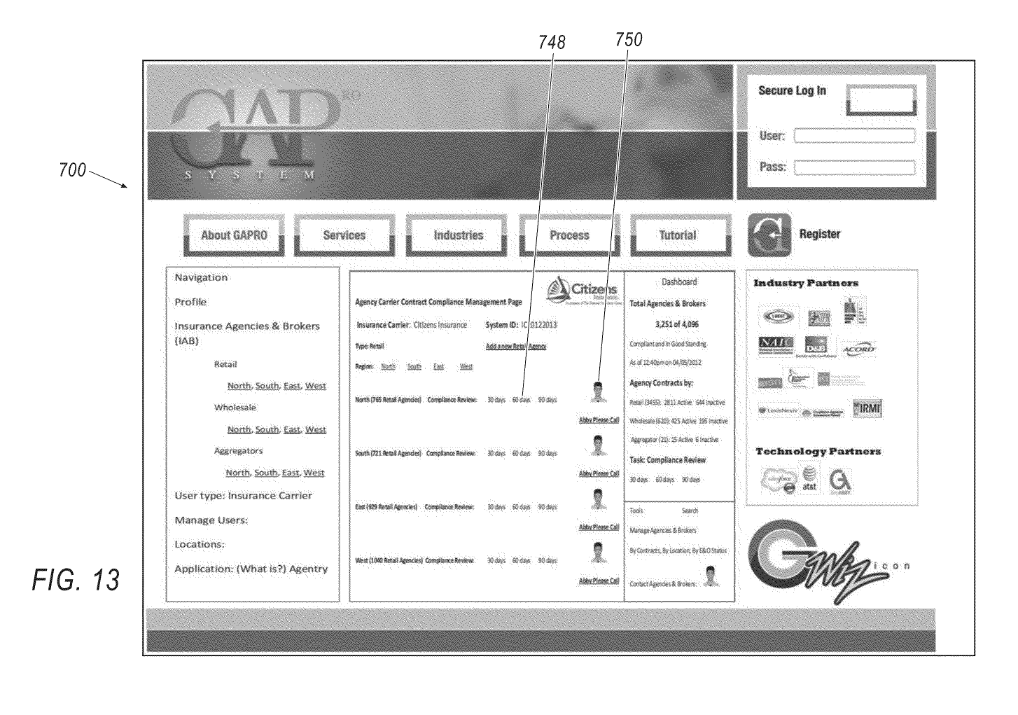

As shown in FIG. 13, user interface 700 may include agency compliance manager 748 and avatar contact manager 750. User interface 700 may provide an ability to add a new agency and to sort by agency type, region, and compliance period, for example 30, 60, or 90 days. Clicking the avatar contact manager 750 for a selected region may initiate communication such as an email or a phone call with an agency contact for the selected region.

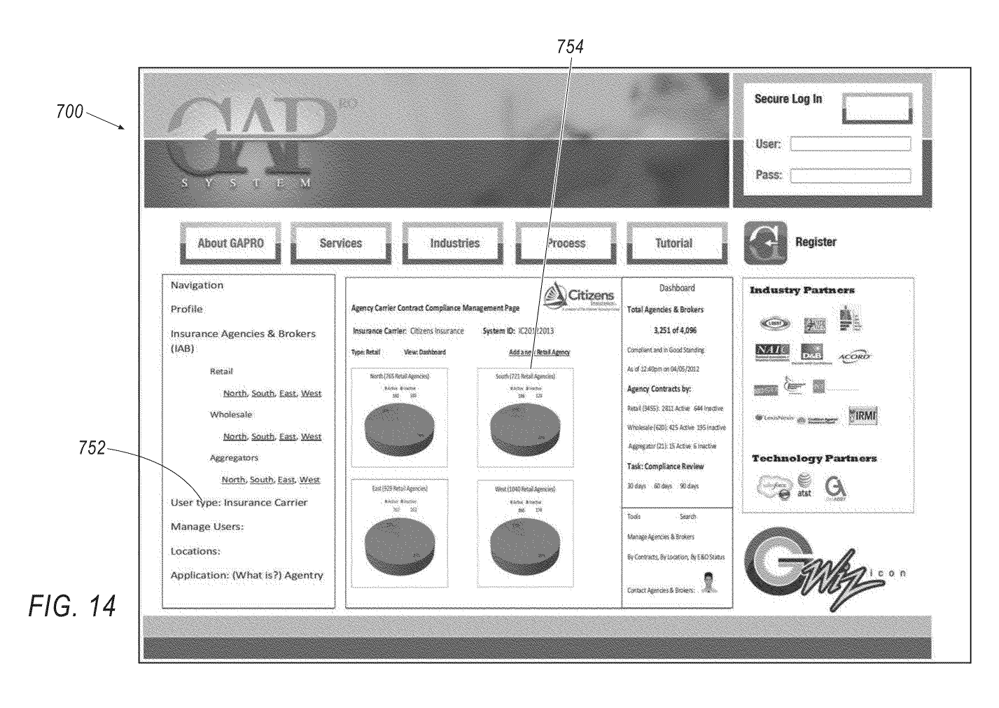

User interface 700 may also include area 752 with a provision of insurance carrier user type and area 754 with a selection of various views. See FIG. 14. For example, area 754 may output one or more pie charts displaying the numbers and percentages of agencies with an active or inactive status. Also, area 754 may provide numbers and percentages for retail, wholesale, and aggregator agencies.

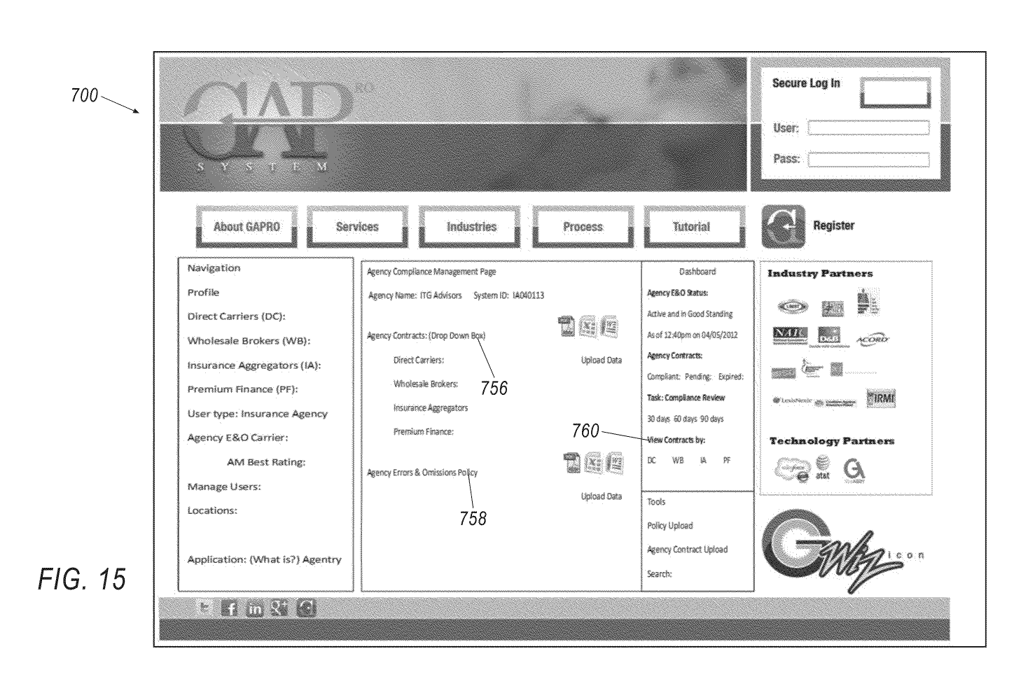

In another embodiment, user interface 700 may provide stakeholder 104 (i.e. insurance carrier 104b) with other tools for managing compliance. See FIG. 15. User interface 700 may include area 756 that allows upload of information by contract type (i.e. direct carriers, wholesale brokers, or insurance aggregators), area 758 that allows upload of agency E&O policy information, and area 760 that allows viewing and managing by contract type. User interface 700 may include additional tabs for insurance agency user type, insurance agency profile registration page, insurance agency contract type, payment gateway, upload information by contract type (i.e. direct carrier, wholesale brokers, or insurance aggregators), upload information by agency E&O policy information, and view and manage by contract type.

User interface 700 may include listing spreadsheets 762 that may be managed by stakeholder 104, for example direct carriers, wholesale brokers, or insurance aggregators. Listing spreadsheets 762 may include columns that allow sorting by stakeholder type (i.e. direct carrier, wholesale broker, or insurance aggregator), policy expiration date, compliance, E&O coverage minimum, status (i.e. active, pending, or inactive), and year started.

System 100 may include additional features such as a service oriented architecture which provides scalability of the system, a scorecard module as an analytics module, and an insurance ratings notification system as an alerts module.

It will be appreciated that the aforementioned method and devices may be modified to have some components and steps removed, or may have additional components and steps added, all of which are deemed to be within the spirit of the present disclosure. Even though the present disclosure has been described in detail with reference to specific embodiments, it will be appreciated that the various modifications and changes can be made to these embodiments without departing from the scope of the present disclosure as set forth in the claims. The specification and the drawings are to be regarded as an illustrative thought instead of merely restrictive thought.

What is claimed is:

1. A computer based system for managing insurance compliance comprising:
a computer;
software that is configured to receive login information of a user stakeholder including at least one of an insurance agency, insurance carrier, policy holder, or verifier entity;
data storage including insurance data of other stakeholders including insurance agencies, insurance carriers, policy holders, and verifier entities;
secured web services platform connecting the software to the data storage; and
interface for the user stakeholder to access insurance data of the other stakeholders,
whereby the system is a tool to manage insurance compliance.

2. The system of claim 1, wherein the computer includes a desktop, laptop, or tablet computer.

3. The system of claim 1, wherein the computer includes a mobile phone.

4. The system of claim 1, wherein the data storage includes online data storage.

5. A method for managing insurance compliance comprising:
providing a user interface connecting a computer to a database;
receiving login information to access an insurance status from the database, the insurance status information being of an insurance agency, insurance carrier, policy holder, or verifier entity; and
indicating the insurance status on the user interface.

6. The method of claim 5, wherein the user includes an insurance agency.

7. The method of claim 5, wherein the user includes an insurance carrier.

8. The method of claim 5, wherein the user includes a policy holder.

9. The method of claim 5, wherein the user includes a verifier entity.

10. The system of claim 5, wherein the insurance data includes insurance status.

11. The method of claim 5, wherein the insurance data includes real-time verification of insurance.

12. The method of claim 5, wherein the insurance data includes an indication of compliance with an insurance contract.

13. The method of claim 5, wherein the insurance data includes an indication of payment status of insurance premiums.

14. The method of claim 5, wherein the insurance data includes an insurance claims history.

15. The method of claim 5, wherein the insurance data includes an A&M Best Rating.

16. A method for managing insurance compliance comprising:
providing a user interface connecting a computer to a database;
receiving login information to access insurance data from the database, the insurance data including insurance contract terms and insurance status;
comparing the insurance contract terms to the insurance status to determine contract compliance; and
indicating contract compliance to the user interface.

17. The method of claim 16, wherein the database includes insurance data of an insurance agency, carrier, and policy holder.

18. The method of claim 16, wherein the contract compliance is automatically distributed to an insurance agency.

19. The method of claim 16, wherein the contract compliance is automatically distributed to an insurance carrier.

20. The method of claim 16, wherein the contract compliance is automatically distributed to a policy holder
